(19) United States
(12) Patent Application Publication
(10) Pub. No.: US 2003/0046194 A1
(43) Pub. Date: Mar. 6, 2003

(54) Posting lines

(76) Inventors: Glenn Raymond McClendon III, Arlington, VA (US); Gilbert Allan Mozingo, Durham, NC (US); Dale Robert Kress, Centreville, VA (US); Robert Michael Giudice, Westchester, IL (US); Phuong Hue Ha, Vienna, VA (US)

Correspondence Address: STAAS & HALSEY LLP, 700 11TH STREET, NW, SUITE 500, WASHINGTON, DC, 20001, US

(21) Appl. No.: 09/923,362

(22) Filed: Aug. 8, 2001

(51) Int. Cl. G06F 17/60

(52) U.S. Cl. 705/30

(57) ABSTRACT

The present invention is a computer implemented accounting system which executes accounting transactions and creates and stores posting lines based upon the executed accounting transactions.

### BACKGROUND OF THE INVENTION

1. Field of the Invention

The present invention relates to accounting systems. More particularly, the present invention relates to a table-driven accounting system that places all of the rules and controls pertaining to different types of accounting documents into user-configurable and modifiable tables, and uses the table-driven rules to create posting lines. Posting lines allow for accounting transactions to be verified and modified by the user before the transactions are updated to the accounting system files.

2. Description of the Related Art

Prior art paper-based accounting systems typically consist of bookkeepers who enter multiple journal entries for daily accounting activities. These entries are then collected into various ledgers to serve as the accounting records that form financial statements. The bookkeepers who record the daily accounting activities typically have a superior level of accounting knowledge over other individuals within an organization, such as those individuals who receive and spend funds for the benefit of the organization.

Prior art automated accounting systems generally collect the knowledge that the bookkeepers have and incorporate it into complex computer code. Users can perform many different types of activities in accounting systems that provide budgeting, procurement and revenue services. Updates to system data are made based on these different types of activities, recorded into the system through an interface known as documents. The computer code takes clues from what a user enters on a document to create accounting entries and updates to the system. Most of these controlling features in the logic are hard-coded directly in the application software code. Any modification to suit special needs of a client has to be done through computer code modifications. This is often a complex process that involves studying the existing code, determining where the modifications need to be made, making the modifications, and then testing the modifications thoroughly to insure that no errors were created in the process.

With such prior art accounting systems, updating the systems is generally performed on a document by document basis. Such a decentralized updating process typically produces different results until each and every update is evaluated for accuracy. In addition, maintenance of such updating logic becomes difficult for system-wide changes, as the changes have to be incorporated into many different areas, and recompilation of computer code is required. The end result of such updating logic is typically never shown to a user before or after acceptance of a document, resulting in uncertainty in document accuracy.

Further, existing accounting systems have several other inherent problems. For example, errors are often created by users with a lack of accounting knowledge who are unable to verify the results of their transactions until the transactions are posted to a journal, or posted to other accounting related files. Moreover, if the users need to make modifications to their transactions, the users typically need to enter in adjustment transactions that negate or cancel out the original journal entries, a process that is prone to human error.

Another problem with prior accounting systems occurs during accounting transactions, including grants, projects, jobs, etc., performed for cost accounting entities. These accounting transactions accumulate costs that are later submitted to one or more 3^{rd} parties for reimbursement. The calculation of the reimbursement is performed using journal entries from the original transactions. This reimbursement process generates new journal entries for the reimbursement. Thus, the original journal entries do not reflect how costs are ultimately submitted for reimbursement, which prevents cost accountants from tracking disbursements and reimbursements effectively.

Therefore, a need exists for an accounting system that is easy and flexible to update without having to recompile computer code, that allows users to verify the results of their transactions before they are posted to budget and accounting files, and that automatically negates original accounting entries when transaction modifications are made before transactions are posted to accounting files.

### SUMMARY OF THE INVENTION

It is an aspect of the present invention to allow users performing accounting transactions to create and store posting lines.

It is a another aspect of the present invention to provide an audit trail of which debit and credit transaction postings have occurred.

It is a further aspect of the present invention to allow users to see how their transactions will be posted to budget and accounting files before the transactions are actually posted.

It is yet another aspect of the present invention to allow users to correct posting lines entries, if necessary, before the user's transactions are posted.

It is an additional aspect of the present invention to prevent the necessity of correction entries from having to be entered.

It is a further aspect of the present invention to eliminate the need for users to perform back adjustment entries.

It is another aspect of the present invention to recreate journals, budget tables, accounting control tables from posting lines.

The above aspects can be attained by a system and method for accounting, comprising executing accounting transactions, and creating and storing posting lines based upon the transactions.

The above aspects can also be attained by a system and method for accounting, comprising performing accounting transactions, and creating and storing an audit trail of the transactions.

The above aspects may further be attained by a method for altering the behavior of an accounting system, comprising modifying table-based rules controlling posting lines in real-time without the need for recompilation of source code controlling the accounting system.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 depicts a high level flow of how posting lines are created.

FIG. 2 shows a high level overview of an embodiment of the present invention.

FIG. 3 shows a more detailed view of the embodiment of the present invention shown in FIG. 2.

FIG. 4 is a data relationship diagram depicting the data relationships between an event category, event types, and posting codes.

FIG. 5 is a flow depicting front-end split logic.

FIG. 6 details the flow of the event type processor, according to an embodiment of the present invention.

### DESCRIPTION OF THE PREFERRED EMBODIMENTS

Before discussing the features of the present invention, a description of the terms used in the discussion herein will be provided.

A Document Processor is application code that contains logic for editing document specific fields.

An Accounting Line is the place where users enter information related to accounting activities.

An Event Type is a high level activity assigned to an accounting line associated with a document. An event type controls smaller components of accounting activity that are used to perform accounting, budgeting, and/or non-accounting activity. An event type defines specific rules for data entry, including but not limited to referenced transactions, customer codes, vendor codes and all of the defined types of account elements in the accounting system of the present invention. Each event type is grouped within an event type category.

An Event Type Category is a level of grouping for event types. An event type category describes how many posting pairs are created for the event types belonging to the event category.

A Posting Pair is used to associate posting code to a debit or credit side of an accounting activity. A posting pair contains both an offset and non-offset or just a non-offset. Also, each side of a posting pair may be a debit or credit. Posting Pairs can be defined at the event category level as templates and are assigned posting codes when an event type is created within each event category at the event type level. Each posting pair defined within an event type would result in a posting line.

A Posting Line is the result of processing an accounting line. A posting line comes in pairs with a debit and a credit or can be just a debit or a credit. Posting lines are used to update tables in budget and accounting files. Posting lines do not necessarily have to be written to any accounting files.

The creation of posting lines not only enables a universal source of information for updates and for the creation or recreation of budget and accounting files within the system, but also allows users to view accounting entries online, and to make corrections or modifications before postings are made to the budget and accounting files.

Reference will now be made in detail to the preferred embodiments of the present invention, examples of which are illustrated in the accompanying drawings, wherein like reference numerals refer to like elements throughout.

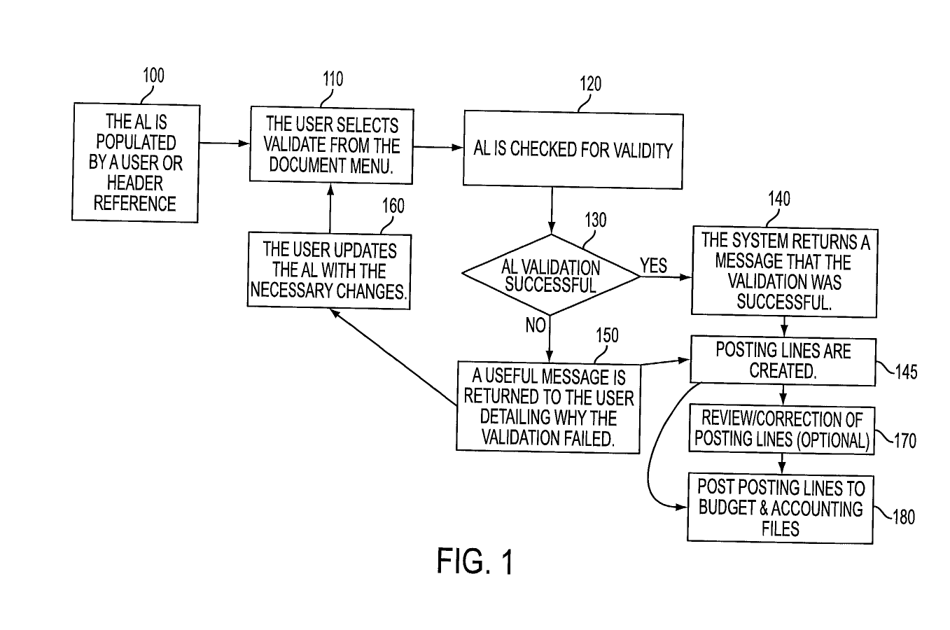

FIG. 1 depicts a high level flow of how posting lines are created. At operation 100, a user enters accounting line information into the accounting line, or, alternately, accounting line information is created from an accounting line header reference and automatically entered onto the accounting line. A document processor is used to edit document specific fields, and the accounting line editor is then used to parse the accounting line. At operation 110 the user selects ‘validate’ or other synonymously functional software command in order to validate the information entered at operation 100. At operation 120, the accounting line is checked for validity. This involves performing any combination of inferences, combination validations, required element edits, document control table edits, document-specific edits, event-type edits, or other required or configurable edits on the accounting line information. At operation 130, the accounting system determines if the accounting line validation was successful.

If the validation at operation 130 was successful, then processing proceeds to operation 140, where the system returns the message that validation was successful. Processing next proceeds to operation 145.

At operation 145, posting lines are created based on the following information: information on the accounting line; data directly associated with an item on the accounting line, e.g., document history amounts associated with a referenced transaction ID; items entered on the header section of the document, e.g., the form of payment that a customer is using; data directly associated with a header item, e.g., a billing profile associated with a customer code; and system-wide options, such as how to handle overpayments. Other information used in the creation of posting lines includes, but is not limited to including, event type information, posting code information, and functional area information. Posting lines may or may not be created based on the event type.

If, on the other hand, it is determined at operation 130 that the accounting line validation was not successful, then processing proceeds to operation 150, where a message is returned to the user explaining why the validation failed, and what changes need to be made to the accounting line in order to have a successful validation. According to an embodiment of the present invention, processing proceeds from operation 150 to operation 145, at which point posting lines are created, even though the validation at operation 130 was not successful. According to another embodiment of the present invention, from operation 150 processing next proceeds to operation 160, where the user updates the accounting line with any necessary changes outlined in operation 150. From operation 160, processing proceeds to operation 110, as described above.

In summary, an edit on the accounting line generally occurs before the creation of any posting lines. According to an embodiment of the present invention, if the edit is unsuccessful, posting lines are created, even though the posting lines may contain errors. According to another embodiment of the present invention, if the edit is unsuccessful, then posting lines are not created. Instead, error messages will be returned to the user that pertain only to the problem accounting lines. When the edit is successful, then posting lines are created.

Operation 170 is an optional operation. At operation 170, after the posting lines are created, a user may go, for example, to a posting line tab of a document previously processed to review the generated posting lines to ensure that the correct postings were generated. The user has the choice of viewing the posting lines in a number of different ways. One posting line viewing method allows for viewing by a certain commodity or a view showing an aggregate of posting lines at a higher level than the accounting line. An alternate posting line viewing method allows for the viewing of all generated posting lines for a document. A further viewing method allows for the viewing of error messages resulting from the attempt to generate particular posting lines.

Advantageously, the viewing of the posting lines may be performed before the posting lines are posted into budgets and accounting files. Further, the accounting transactions which were used in the creation of the posting lines may be reviewed, modified, and edited in order to correct the incorrect accounting transaction entries on the accounting line. In addition, accounting transaction amounts may be modified by a user without knowledge of what the original or previous transaction entries were, i.e., accounting transaction amounts may be modified without the need for the user to refer back to original or previous accounting transaction amounts. The posting lines themselves may also be modified and edited either online or offline in order to correct the error messages.

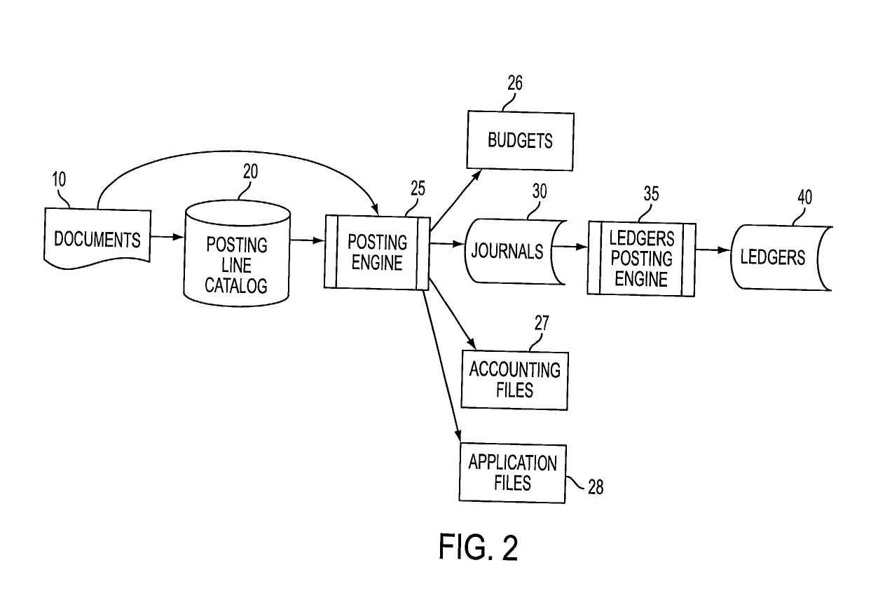

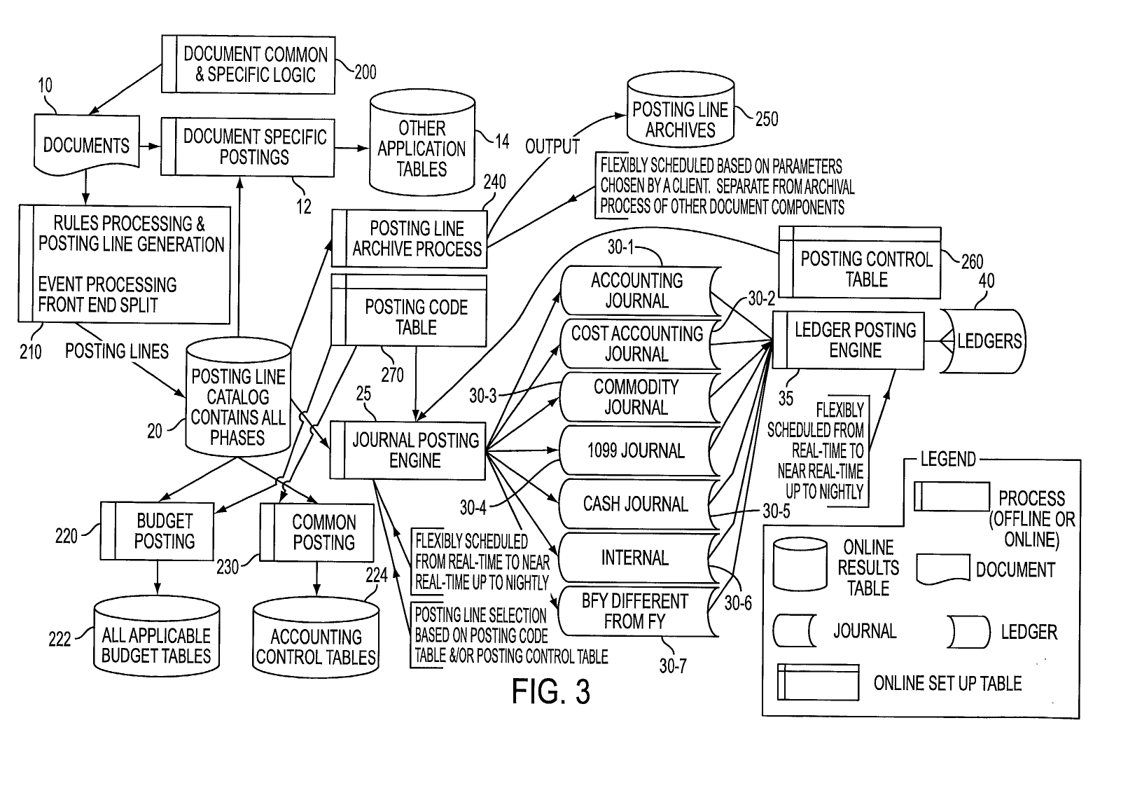

At operation 180, the posting lines are posted to budgets and accounting files, as is more fully described in the discussion of FIGS. 2 and 3 below. Alternately, the postings to budget and accounting files may also be performed at a later user-specified time.

The following are examples of Posting Lines according to an embodiment of the present invention. Booking an expenditure accounting event, which may, for example, be entered by a user, into multiple accounting events at the posting line level. A user enters one funding expenditure at the accounting line level. Next, when the document is processed, one (or more, depending on the table configurations) accounting events are generated at the posting line level, such as a payment authorization event and a fixed asset event.

EXAMPLE 1
Encumbrance for $100.00

| AL ID | COA | | Event Type | AL Line Amt | | AL Close Amt | | |
|---|---|---|---|---|---|---|---|---|
| 1 | COA1 | | E001 | 100.00 | | 0.00 | | |
| PL ID | COA | Posting Code | Event Type | PL Line Amt | PL Post Amt | PL Closed Amt | Cr/Dr | Line Type |
| 1 | COA1 | P001 | E001 | 100.00 | 100.00 | 0 | DR | S |

Example 1 is an example of an encumbrance for a purchase order of $100. At the accounting line, a user enters 100.00, and the event type E001 and chart of account code COA1. After the accounting line is validated, a posting line PL ID 1 is created for chart of account code COA1, event type E001 with line amount for 100.00 and a posting line post amount for 100.00. The CR/DR field indicates the line is a Debit and the Line Type S indicates that it is a standard line and can be liquidated.

EXAMPLE 2
Payment Authorization for $20.00 - referencing PO in Example 1

| AL ID | COA | | Event Type | AL Line Amt | | AL Close Amt | | |
|---|---|---|---|---|---|---|---|---|
| 1 | COA1 | | E001 | 20.00 | | 0.00 | | |
| PL ID | COA | Posting Code | Event Type | PL Line Amt | PL Post Amt | PL Closed Amt | Cr/Dr | Line Type |
| 1 | COA1 | P001 | E001 | 20.00− | 20.00− | 0 | Cr | L |
| 2 | COA1 | P002 | E001 | 20.00 | 20.00 | 0 | Dr | S |

Update to Encumbrance accounting and posting line above in example 1

| AL ID | COA | | Event Type | AL Line Amt | | AL Close Amt | | |
|---|---|---|---|---|---|---|---|---|
| 1 | COA1 | | E001 | 100.00 | | 20.00 | | |
| PL ID | COA | Posting Code | Event Type | PL Line Amt | PL Post Amt | PL Closed Amt | Cr/Dr | Line Type |
| 1 | COA1 | P001 | E001 | 100.00 | 100.00 | 20.00 | Dr | S |

Example 2 is an example of a payment authorization which references the encumbrance of example 1. At the accounting line, a user enters 20.00 at a payment authorization line that references the encumbrance of example 1. Once the accounting line is validated, at PL ID 1, a posting line with a line amount of 20.00—is created and a posting line with a post amount of 20.00—is created. The Line Type is L on PL ID 1 indicates that the posting line is a liquidation posting line. These entries liquidate or reverse out the 20.00 from the original encumbrance line. PL ID 2 represents the posting line for the payment authorization transaction, and is used to book accounting events for the current transaction. At PL ID 2, a posting line amount is generated for 20.00 and a posting line post amount is generated for 20.00. As a result of the posting lines for the encumbrance transaction in example 1 being referenced, 20.00 is closed at the accounting line level as well as the posting line level.

EXAMPLE 3
Change/Modification to Fund & Amount to PO in example 1

| AL ID | COA | | Event Type | AL Line Amt | | AL Close Amt | | |
|---|---|---|---|---|---|---|---|---|
| 1 | COA2 | | E001 | 120.00 | | 20.00 | | |
| PL ID | COA | Posting Code | Event Type | PL Line Amt | PL Post Amt | PL Closed Amt | Cr/Dr | Line Type |
| 1 | COA1 | P001 | E001 | 20.00 | 0 | 20.00 | Dr | S |
| 2 | COA1 | P001 | E001 | 0 | 80.00− | 0 | Cr | S |
| 3 | COA2 | P001 | E001 | 120.00 | 120.00 | 0 | Dr | S |

After consolidation (PL 1 and 2 consolidated):

| | | | | | | | | |
|---|---|---|---|---|---|---|---|---|
| 1 | COA1 | P001 | E001 | 20.00 | −80.00 | 20 | Cr | S |
| 2 | COA2 | P001 | E001 | 120.00 | 120.00 | 0 | Dr | S |

Example 3 is an example of a modification of the encumbrance of example 1. At the account line, a user enters 120.00 with a new chart of account code COA2. The present invention allows the user to enter in the modification to the accounting line, in this case the amount of $120.00 and chart of account codes, without knowing the original transaction amount or chart of account code. Advantageously, the user does not need to have an understanding of what adjustment transactions are needed to adjust the accounting files. The present invention has the ability to compute the adjustments according to information from the posting line.

After the accounting line is validated, the present invention makes sure that an amount that has been closed stays closed, or else the present invention will account for the amount. At PL ID 1, one posting line is created with an amount equal to 20.00 indicating that 20.00 has been closed at the accounting line level. Typically, the posting line closed amount is always equal to the posting line amount. PL ID 2 reverses out the previous transaction, which is the outstanding encumbrance that was booked to the original chart of accounts funding strip. PL ID 3 is booked against a new chart of element for the current transaction. Since the chart of accounts was changed at PL ID 3, only PLID 1 and PL ID 2 are consolidated. After consolidation, PL ID 1 and PL ID 2 are consolidated into PL ID 1, and PL ID 3 is renamed PL ID 2.

FIG. 2 shows a high level overview of an embodiment of the present invention. According to this embodiment, a complete and accurate audit trail of past accounting transactions is maintained in a posting line catalog for the purpose of financial reporting and posting. Additionally, the present invention archives journal and ledger entries as they occur. The present invention utilizes posting line catalog 20 for storing posting lines created from documents 10. Within posting line catalog 20, there is information that identifies whether or not a Posting Line has been posted to budget and accounting files. This allows the system of the present invention the flexibility of performing postings of budgets and accounting files at the time of Posting Line creation, which is typically during document processing, or, alternately, to defer the postings to a later time. Alternately or in addition to, documents 10 maybe used as input to posting engine 25.

Documents 10 may comprise any one or more of the following documents listed below. The following list is for illustrative purposes only, and it is to be understood that the present invention is able to work with additional types of documents not explicitly described herein: a Payment Voucher authorizes the spending of money and may be use to pay an outside vendor or to transfer money within a governmental entity; an Automated Payment Voucher is identical to a Payment Voucher document with the exception that it is generated from the Automated Payment Voucher process; a Payment Voucher from Multi-Payee Voucher is used to pay vendors and is generated from the Multiple Vendor Payment Voucher document; a Multiple Vendor Payment Voucher is used to enter payments for multiple vendors with the same accounting distribution—when processed, this creates a Payment Voucher from Multi-Payee Voucher documents; a Payroll Voucher records payroll-related expenditures that have been previously distributed. This document may be used to record the accrual of liabilities and does not lead to actual disbursements; a Quick Payment Voucher authorizes the spending of money and may be use to pay an outside vendor; a Vendor Payment Voucher authorizes the spending of money and may be use to pay an outside vendor; Manual Warrant records manually written checks or warrants in the accounting system of the present invention; a Journal Voucher is a generalized document that records accounting events that cannot be records using other financial system document; an Invoice recognizes monies an entity expects to receive in the future. The monies may be for services rendered or for reimbursement; an Internal Voucher acts as an invoice for the seller and a payment voucher for buyer for an internal purchase or sale; an internal purchase/sale as a purchase or sale in which the seller is an organizational entity within the institution, rather than an outside vendor; a Purchase Order records the ordering of goods or services and encumbers the funds necessary to pay for the order; a Requisition records the intention to purchase goods or services and pre-encumbers the funds for reporting; a Cash Receipt records all monies collected, including collections against outstanding accounts receivables, cash basis revenue and non-revenue-related receipts; an Expense Budget establishes and maintains line item expense budgets; and an Appropriation and Allotment records an appropriation and related allotments of the appropriation.

Posting line catalog 20 contains posting lines for documents 10 in various states, including but not limited to rejected, accepted, pending, and hold states. When a document is edited successfully to a point where posting lines are created, the posting lines are stored in posting line catalog 20 for all documents. Alternatively, the present invention allows for any user-selected document, such as budgeting documents, to have their associated posting lines excluded from posting line catalog 20. Posting lines for documents that are accepted and ‘ready to post’ are typically the only posting lines which are written to journals 30 and ledgers 40, budgets 26, accounting files 27, and application files 28. Journal posting engine 25 receives the accepted posting lines from posting line catalog 20 and writes them to one or more journals 30, budgets 26, accounting files 27, and/or application files 28. Application files 28 are document specific updates that are tracked on-line. When a record is created in posting line catalog 20, a flag is set for the record that controls whether or not the record is ready for journal posting. Any record created for a posting line that is of a status other than ‘accepted’ typically has a flag set indicating ‘not ready to post’. The records created for accepted lines typically have flags indicating ‘ready to post’. Journal posting engine 25 selects those records from posting line catalog 20 which are ‘ready to post’. Once a record is posted, the flag associated with the document is set to a value indicating that the document has been ‘posted’. Typically, journal posting engine 25 does not select a record that is marked ‘posted’ or ‘not ready to post’. Ledger posting engine 35 then receives journal information from journals 30 and uses a journal control table (not shown in this high level overview) to determine which ledgers 40 are to be written to.

In another embodiment, the posting line catalog may also be used as a single source to create or recreate budgets 26, journals 30, accounting files 27 and/or application files 28 in cases where these files have become corrupt, or in cases where a new file has been created such as a new journal file. Posting lines may be selected for updating based on document type, fiscal year, date, or any other information available on the posting line. In the case of corrupted data, the corrupted data is purged from the budget, journals, accounting files and/or application files. The posting line catalog 20 next feeds posting lines into posting engine 25 which creates new records for the accounting files of budgets 26, journals 30, accounting files 27, and/or application files 28.

FIG. 3 shows a more detailed view of the embodiment of the present invention shown in FIG. 2. A user enters accounting line information onto the accounting line of document 10. Document common & specific logic 200 validates that all entries entered by the user are correct. Once validated, the accounting line information of a document is sent to rules processing/posting line generation engine 210, where the entered accounting line information is checked for validity, and where posting lines are created. Rules processing/posting line generation engine 210 operates on a real-time basis, requiring only a submit document action by the user or application. Before the created posting lines are written to posting line catalog 20, rules processing/posting line generation engine 210 determines whether or not the posting line should be posted by reading a journal posting indication value for the document being processed. If the journal posting indication value is a value which indicates that asynchronous posting, then the posting lines are stored in posting line catalog 20 as ‘not ready to post’. If, on the other hand, the posting line indication value is synchronous, then the posting lines are stored in posting line catalog 20 as ‘ready to post’. The journal posting indication value may be used, for example, so that items such as automatic disbursements may be reviewed and manually approved before being recorded into an accounting journal.

The event type processor, which is a component of the rules processing and posting line generation engine 210, contains rules and procedures pertaining to one or more event types. Event type rules consist of what may, may not, or must be on an accounting line for certain fields; what the posting codes are for each pair; and, in certain cases, where the event type may or may not be used. After these rules are checked, the event type processor creates all the necessary posting lines, including offsets, for the event type and data on the accounting line.

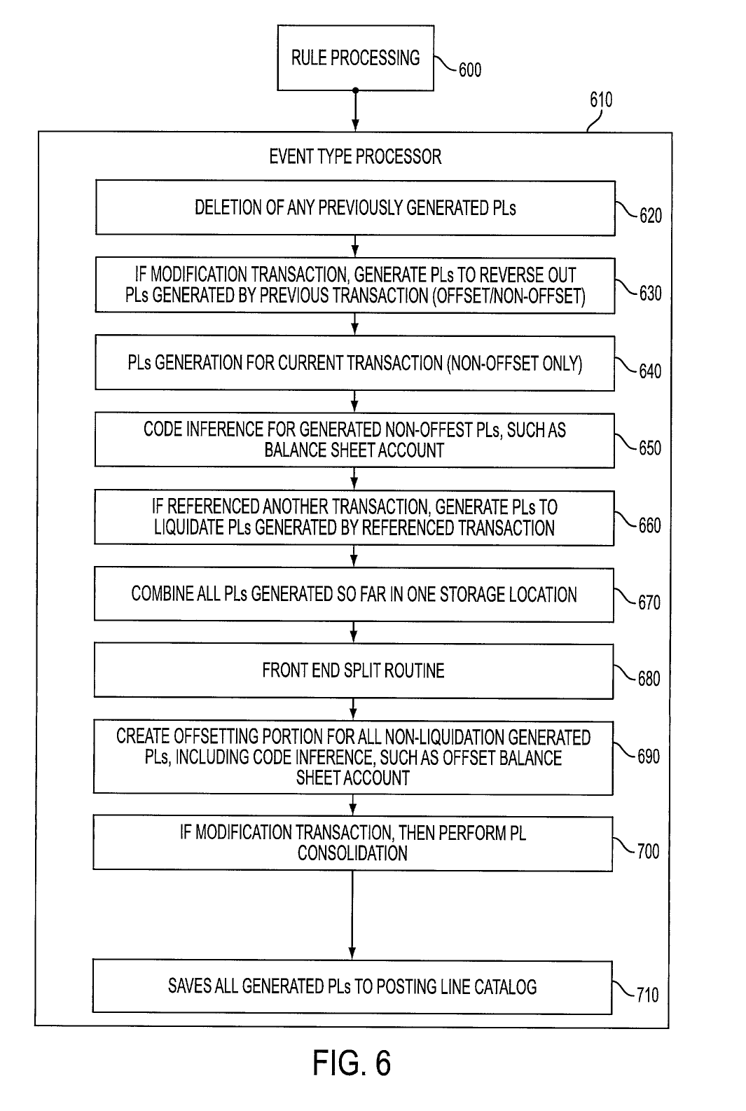

FIG. 6 details the flow of the event type processor, according to an embodiment of the present invention. Referring now to FIG. 6, rule processing unit 600 feeds accounting line information into event type processor 610. At operation 620, any posting lines that were generated previously for non-accepted states will be deleted, and processing proceeds to operation 630. At operation 630, event type processor 610 determines if the current transaction is a modification transaction. If so, then posting lines are generated to reverse out posting lines generated by the previous transaction by referring back to the original document, and processing proceeds to operation 640. If the current transaction is not a modification transaction, then processing proceeds directly to operation 640.

At operation 640, posting lines are generated for the current transaction, and processing proceeds to operation 650.

At operation 650, code inferences are generated for non-offset posting lines, such as, for example, a balance sheet account. Processing then proceeds to operation 660.

At operation 660, if another transaction (i.e. document) is referenced, then a reference logic sub-routine (RLSR) is invoked, posting lines are generated to liquidate posting lines generated by the referenced transaction. The reference logic sub-routine is a routine that is generally invoked when there is a valid reference on an accounting line. The present invention determines all the lines that exist on a referenced document for each posting code pair designation. By linking the defined posting codes for event types to these pairs, the present invention is able to determine exactly which pair of posting codes are needed for any posting line on a referencing document. Because of this, the present invention is able to infer the actual posting line numbers and specialized area flags for a user. All that user has to do is reference an accounting line on the referenced document in the accounting line of the referencing document. Alternatively, some documents may have this part of referencing completed by allowing a complete document to be referenced in the header or other sections of the referencing document. In doing so, accounting lines are then created for each of the referenced document's accounting lines on the referencing document. Processing proceeds to operation 670.

If no other transaction is referenced, then processing proceeds directly to operation 670.

At operation 670, all posting lines generated are stored in a single storage location, and processing proceeds to operation 680.

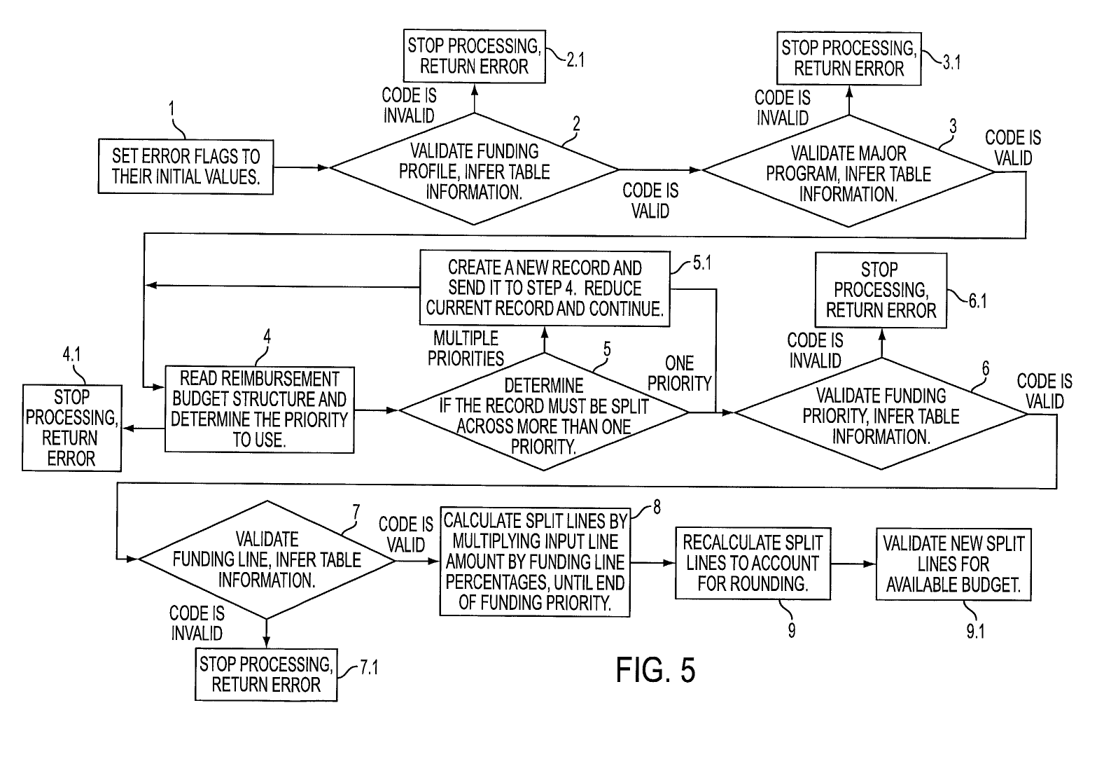

At operation 680, a front-end split routine is optionally invoked, which determines which posting lines to split, as further detailed in the FIG. 5 discussion below. Processing then proceeds to operation 690.

At operation 690, the offsetting portion for all non-liquidation generated posting lines are created, including code inferences, such as, for example, an offsheet balance account, and processing next proceeds to operation 700.

At operation 700, if the current transaction is a modification transaction, then posting lines are consolidated, as is described below, and processing proceeds to operation 710. If the current transaction is not a modification transaction, then processing proceeds directly to operation 710.

At operation 710, all generated posting lines are saved in a posting line catalog, such as posting line catalog 20. Also at operation 710, each posting line is assigned a unique ID.

As mentioned above, the event type processor also contains consolidation logic to consolidate posting lines, in order to save storage space in posting line catalog 20. For instance, the posting line consolidation routine according to the present invention contains logic/rules to consolidate multiple posting lines that have the same consolidation key into one single posting line. The non-key fields, including amounts on the posting lines are combined when a new consolidated posting line is created.

Another advantage of consolidation, in addition to saving storage space, is that it allows for users to enter in adjustment transactions for a given business transaction without knowledge of what adjustment amounts are needed for the journal. The consolidation process automatically computes the necessary adjustment amounts needed for the journal entries.

The consolidation key can be redefined easily to incorporate more attributes or to remove attributes. Further, the consolidation key may be easily modified to accommodate various client sites needs. Importantly, the consolidation process may be table driven so that such additions, deletions, and modifications may be performed with ease.

For example, consolidate keys for posting line consolidation may include any of Chart of Accounts elements, Posting Code, and Event Type. Thus, for the following example set of posting lines:

| PL | | Posting | | | | |
|---|---|---|---|---|---|---|
| ID | COA | Code | Event Type | PL Line Amt | PL Post Amt | Cr/Dr |
| 1 | COA1 | P001 | E001 | 100.00 − | 100.00 − | Cr |
| 2 | COA1 | P002 | E001 | 80.00 | 80.00 | Dr |
| 3 | COA1 | P001 | E001 | 40.00 | 40.00 | Dr |
| 4 | COA1 | P002 | E001 | 40.00 − | 40.00 − | Cr |
| 5 | COA2 | P001 | E001 | 50.00 | 50.00 | Dr |
| 6 | COA1 | P001 | E002 | 55.00 − | 55.00 − | Cr |

Based on keys defined above, PL 1 is consolidated with PL 3, PL 2 is consolidated with PL 4, PL 5 is not consolidated, and PL 6 is not consolidated, resulting in the following set of posting lines:

| | | | | | | |
|---|---|---|---|---|---|---|
| 1 | COA1 | P001 | E001 | 60.00 − | 60.00 − | Cr |
| 2 | COA1 | P002 | E001 | 40.00 − | 40.00 − | Cr |
| 3 | COA2 | P001 | E001 | 50.00 | 50.00 | Dr |
| 4 | COA1 | P001 | E002 | 55.00 − | 55.00 − | Cr |

Referring now back to FIG. 3, optionally, the rules processing and posting line generation engine 210 can invoke a front-end split processor. The purpose of the front-end split is to improve management of cost accounting entities that are reimbursed partially or fully) for their disbursements. In these situations, the reimbursement may be paid by an outside entity (e.g. the federal government or another grantor) or another part of the same entity (e.g. another department in the same government). For example, funding for a interstate highway in the state of Virginia is paid according to the following distribution: 60% from the State Highway department, and 40% from the Federal government. The front-end split improves management in these situations by calculating the accounting distributions that will be used for reimbursement and recording them with the original transaction at the point of entry. The front-end split process automatically generates multiple posting lines, based on rules of distribution from a reimbursement structure, at the point of entry to which the transaction will ultimately be submitted for reimbursement. Capturing this information up front on the disbursement transaction explicitly links the disbursement to its reimbursement coding, allows the appropriate budget lines to be updated initially instead of after the fact, allows for more accurate reporting, and permits accurate cash management by funding source between reimbursement billing cycles.

Optionally, the event type processor may invoke an optional front-end split subroutine to create multiple posting lines, whose processing is transparent to a user and which is typically called before the posting lines are written to budget and accounting files. The front-end split subroutine is a subroutine which is invoked when, for example, a cost accounting element exists on the accounting line that is setup for front-end splits. This feature replaces the funding strips on one or more posting lines with established funding strips for the cost accounting element. In many cases, it may split one line into many separate lines. In such cases, the result will be one or more posting lines with a total amount equal to the original posting line's amount that was split. After these lines are created, the event type processor will default any object, revenue source, or balance sheet accounts for all posting lines if a user did not enter the value needed according to the sequence defined on the Posting Code Table. The event type processor will then ensure that the code defaulted or entered meets any specific criteria necessary.

Splitting an expenditure according to the funding rules for a program is another example of posting lines according to an embodiment of the present invention. This is an online process which reads posting lines for such expenditures, determines the funding that should have taken place, and then writes new and adjusting entries.

EXAMPLE 4
Front End Split

| AL ID | COA | | Event Type | AL Line Amt | | AL Close Amt | | |
|---|---|---|---|---|---|---|---|---|
| 1 | COA1 | | E001 | 100.00 | | 0.00 | | |
| PL ID | COA | Posting Code | Event Type | PL Line Amt | PL Post Amt | PL Closed Amt | Cr/Dr | Line Type |
| 1 | COA1 | P001 | E001 | 100.00 | 100.00 | 0.00 | Dr | S |

Split into (these are saved in Posting Line Catalog instead of the above.)

| | | | | | | | |
|---|---|---|---|---|---|---|---|
| 1 | COA1 | P001 | E001 | 50.00 | 50.00 | Dr | S |
| 2 | COA2 | P001 | E001 | 30.00 | 30.00 | Dr | S |
| 3 | COA3 | P001 | E001 | 20.00 | 20.00 | Dr | S |

Example 4 is an example of a 50-20-30 front end split. A user enters 100.00 at the accounting line level, PL ID 1 is created with 100.00 placed in the posting line amount and posting line post amount fields. This posting line is split into 3 separate posting lines, with amounts of 50.00 placed in the posting line amount and posting line post amount fields of new PL ID 1, 30.00 placed in the posting line amount and posting line post amount fields of new PL ID 2, and 20.00 placed in the posting line amount and posting line post amount fields of new PL ID 3.

FIG. 5 is a flow depicting front-end split logic. At operation 1, error flags are set to their default values. For example, according to an embodiment of the present invention, the following error flags are listed with their corresponding default values shown in parentheses:

Funding_Profile_Not_Found (N);

Funding_Profile_Reimbursement_Reimbursement_Status (A);

Major_Program_Not_Found (N);

Funding_Priority_Budget_Line_Not_Found (N);

Funding_Priority_Not_Found (N);

Funding_Priority_Reimbursement_Reimbursement_Status (A);

Funding_Line_Not_Found (N);

Funding_Line_Reimbursement_Reimbursement_Status (A); and

Funding_Line_Budget_Error (N).

At operation 2, data from an input record is read, and a record from a Funding Profile table is read that shares the same key fields as the input record. If no corresponding record is found, the Funding_Profile_Not_Found flag is set to “Y”. The processing for this transaction then terminates at operation 2.1. Otherwise, a Funding Profile record exists, and the status of the Funding Profile is determined. If necessary, the Funding_Profile_Reimbursement_Status_Flag is set to an appropriate value: “I” (Inactive) or “S” (Suspended).

At operation 3, using the input record's data, the record from the Major Program table that shares the same key fields as the input record is read.

If no such record is found, then the Major_Program_Not_Found flag is set to “Y”, and processing for this transaction ends at operation 3.1. Otherwise, a Major Program record exists, and the Reimbursable Budget Structure field is next read and stored in a temporary field. Further, the Front-End Split indicator is read and stored as a holding value for later processing.

At operation 4, the budget table is read to determine the Budget Structure values stored from the Major Program table. The input fields are used as keys and a Funding Priority of low values is used for the first read. A “Perform Until” loop is executed and continues to read records with Get Next logic, verifying that each “next” table record has the same codes as the accounting line. The loop is exited if any of the table reads, including the first one, indicates that any of the following are true:

If an End of File is determined, then the Funding_Priority_Budget_Line_Not_Found flag is set to “Y”, and processing proceeds to operation 4.1, where the processing for this transaction terminates.

If key fields of table record do not match the accounting line's Major Program and Funding Profile, then the Funding_Priority_Budget_Line_Not_Found flag is set to “Y”, and the processing for this transaction then terminates at operation 4.1.

If the key fields of table record do match the accounting line's Major Program and Funding Profile, then the dollar amount is compared to the appropriate Available Amount (depending on front-end or back-end split indicator stored in operation 3):

If the Available Amount>0, then the Funding Priority is saved, and processing proceeds to operation 5.

If the UnSplit amount is positive and the Available Amount<0, then the loop is returned to and the next record on the table is tried.

If the UnSplit amount is negative and the Available Amount<0, then “retreat” to the previous priority and use that priority in operation 5.

At operation 5, it is first determined whether the input record is negative or positive. If the input record is positive:

If (the Available Amount (front-end or back-end)<the input record's UnSplit Amount) then the input record must be split across more than one priority. If this is not true, then processing proceeds to operation 6. Otherwise, a new record is created with the same input fields as the current record, but with the dollar amount equal to the difference between the input record's UnSplit Amount and the Available Amount. This new record is then queued at operation 5.1 as the next input file record and processing for the new record recedes to operation 4. Next, the dollar amount for the current is set to equal the budget record's (remaining) Available Amount.

If the input record is negative:

If ((Award Amount—Available Amount)<(−1*input record's UnSplit Amount)) then the input record is determined to be split across more than one priority. If this is not true, then processing proceeds to operation 6.

Otherwise, a new record is created with the same input fields as the current record, but with the dollar amount is set to equal −1*((−1*input record's UnSplit Amount)−(Award Amount−Available Amount)). This new record is queued as the next input file record and processing recedes to operation 5.

The dollar amount of the current record is set to (−1*(Award Amount−Available Amount)). Then processing proceeds to operation 6.

At operation 6, using the input record's data and the finding priority determined in the previous operations, the record from the Funding Priority table (not the budget table) is read that shares the same key fields.

If no such record is found, the Funding_Priority_Not_Found flag is set to “Y”, and processing for this transaction terminates at operation 6.1.

Otherwise, a Funding Priority record exists, the Funding Priority's status is determined. If necessary, the Funding_Priority_Reimbursement_Status_Flag is set to an appropriate value: “I” (Inactive) or “S” (Suspended).

At operation 7, the Funding Line table is read with key fields Department, Funding Profile, Funding Priority, as determined during previous operations, and Funding Line is set to equal low values.

If the record found has key fields that do not match the Department, Funding Profile, and Funding Priority used in the read, then the Funding_Line_Not_Found flag is set to “Y”. The processing for this transaction then terminates at operation 7.1.

Otherwise, the record's key fields match, and processing proceeds to operation 8.

At operation 8, starting with the first Funding Line record found, first look up the Funding Line's status. If necessary the Funding_Line_Reimbursement_Status Flag is set to the appropriate value: “I” (Inactive) or “S” (Suspended).

The accounting line amount is multiplied by the funding line's percentage. The result is rounded to two decimal places. This is the “Calculated Funding Line Amount”.

An output record is generated that has the same fields as the input record and also has the Funding Profile Front-End Split Flag, Funding Line Number, Funding Line Customer, Funding Line Percentage, and Calculated Funding Line Amount determined through the processing.

Next, perform a “Get Next” Funding Line command, until the next table record's (Major Program, Funding Priority, Funding Profile) do not match the fields on the current input file record. Processing proceeds to operation 9.

At operation 9, after all output lines are generated for an input record, the split process accounts for rounding errors by either:

subtracting the percentages from 100%. When the running difference of the percentages is <0.0001, then the last funding line is assumed to be included and the remainder of the UnSplit amount is included in the last funding line; OR by

adding up the total of the output posting line amounts and comparing the sum to the input UnSplit amount (which is the correct amount). Any difference between the two is adjusted to the last generated record.

At operation 9.1, for each output line generated, a budget edit against the Funding Line's budget is performed. The budget table is read for the Budget Structure and stored from the Major Program table. A level code is used to equal to one higher than the Level value stored from the Major Program table. If the output record's split amount is greater than the Available Amount (front-end or back-end, as appropriate ) then the Funding_Line_Budget_Error Flag is set to “Y,” and processing terminates.

Referring now back to FIG. 3, posting lines are contained in a data-structure within catalog 20 and have the following data-fields according to an embodiment of the present invention: a Posting Line Identifier which uniquely identifies a Posting Line (including what documents/versions/Vendor Line/Commodity Line/Accounting Line the posting line belongs to); a Document Function that has the following possible values: New, Modification and Cancellation. Depending on the function, Posting Lines are generated accordingly to create the appropriate postings; a document Phase that has the following possible values: Draft, Pending, Final and Historical. This tracks the lifecycle of all components within a document; an Event Type ID that identifies what accounting event is to be taken; a Posting Pair Type that identifies what Posting Pair within an Event Type that a particular Posting Line was generated from; a Posting Code ID that identifies the actual postings to be taken; a Line Function which has the following possible values: Standard, Non-Standard and Liquidation. This indicates whether this is a Posting Line that liquidates a referenced Posting Line or a new Posting Line for the current document; a Chart of Accounts elements (including Dates/Fiscal Year/Accounting Period/Budget Fiscal Year) which identifies the accounting distribution to be booked by this accounting event; a Debit/Credit Indicator identifies which part of the Posting Lines (offset or non-offset) is debit or credit; a Reference Type has the following possible values: Partial, Final and Memo. The Reference Type identifies the type of reference; a Reference Document ID identifies the document being referenced by the document that a posting line belong to; an Offset Posting Code identifies the actual Postings to be taken for the offset side of the Posting Line; a Journal Posting Indicator has the following possible values: Not Ready, Ready and Posted. The Journal Posting Indicator identifies whether or not a particular posting line is ready, not ready or posted to Journals; a Line Amount is the resulted amount for this posting line; Posting Amount is the Amount to be posted so that the effects equals the Line Amount; a Closed Amount is the amount being referenced (closed) by the referencing Line; the Increase/Decrease Indicator indicates whether or not the modification Accounting Line is an increase or decrease; the Posting Link Number links referenced Posting Line with a Referencing Posting Line; a Budget Posting Indicator has the following possible values: Ready, Not Ready and Posted. The Budget Processing Indicator indicates whether this Posting Line is ready, not ready or already posted to the Budget.

According to an embodiment of the present invention, document specific postings 12 reads any document specific postings contained within posting line catalog 20, and stores document specific or other miscellaneous updates. Other application tables 14 contains a summary of documents and other accounting files. Budget Posting 220 receives posting line information, consolidates based on a budget structure, and updates all applicable budget tables 200 (such as, for example, centralized expense budget tables, appropriation budget tables, and allotment budget tables). Common Posting 230 receives posting line information, consolidates based on the structure of an accounting control table such as a fund, or BSA. Furthermore, budget posting 220 and common posting 230 may receive input from posting code table 270 indicative of which individual applicable budget tables 222 and accounting control tables 224 are to be written to.

Alternately or in addition to, journal posting engine 25 reads the posting lines contained within posting line catalog 20. Journal posting engine 25 may be modified based on the resources, requirements, and desires of a user. Journal posting engine 25 may be running constantly to provide journal updates in real-time, or near real-time, or it may be running on a time-based schedule. Several different instances of posting engine 25 may be running concurrently.

For those posting line records with a posting flag set to ‘ready to post,’ journal posting engine 25 evaluates the ready to post records to determine which budget and accounting files the posting lines are to be posted to, by using information received from posting code table 270 that is indicative of which individual posting codes are to be written to which Journals. Users may adjust the posting code table to fit their individual needs. Moreover, the following information received from posting control table 260 is also used to determine which budget and accounting files the posting lines are to be posted to: a unique ID assigned by the system to each journal and ledger table; a required name, a required short name, a data object name, and an optional description; entries classified as either journal or ledger; entries marked as to whether or not they are available for archiving. Furthermore, all journal entries specify a posting code selection type from a list of posting code selections. Those journals with a posting code selection type of ‘ALL’ have the option of selecting one of the following ‘Information Specific’ fields.

1. Cost Accounting Indication selects only records with a Major Program.

2. BFY Does Not Equal FY selects only records where the two years do not equal.

3. Internal Indication selects only records with an internal fund value.

4. Commodity Indication selects only records with commodity information.

For files determined by journal posting engine 25 to have a ledger designation, a user may provide summarization information. Various date fields along with all COA elements and rollups defined to a system may exist as summarization criteria. Users may select from these various fields to build the components that comprise a ledger summary. Those fields not selected will be ‘summarized off’. Summarized off means that a field will be virtually removed from a record. When fields are removed, the differences between records disappear, so that like records may be summarized into just one record that contains a total amount for all the like records.

As described above, a posting line record may have an archive attribute associated with it. Archiving information may be defined by posting line archive process 240 as a length of time that a record may remain in posting line catalog 20 before being archived in posting line archives 250. Posting line files that were designated as available for archiving contain this type of information. Two fields are typically used. The first field is a list of time frames, such as days, accounting periods, and years. The second field is a numeric value that is associated with the time frame. The archiving process may have additional edits to ensure that these fields will comply with the journal or ledger. For instance, a year-to-date ledger will not have any days on it with which to judge if a record should be archived because the lowest date level on the ledger is fiscal year. In summary, archiving is typically based on the age of the data to be archived. Alternatively, the present invention allows for archiving to be based on a predefined, user-selectable frequency in which to archive data.

Journal posting engine 25 allows for posting lines to be posted into any journal, the following of which are typical, but it is to be understood that the present invention may be configured to post into any type of journal. Accounting journal 30-1 receives and stores posting lines that contain posting codes with the indication of being ‘Accounting’ codes. Cost accounting journal 30-2 receives and stores posting lines with a flag in a ‘program field’, regardless of the event type. Commodity journal 30-3 receives and stores posting lines with a flag in a ‘commodity code field’, regardless of the event type. 1099 journal 30-4 receives and stores posting lines that contain posting codes with the indication of being ‘1099 Reporting’ codes. An example of such posting codes is Cash Expenditure. Cash journal 30-5 receives and stores posting lines that contain posting codes with the indication of being ‘Cash’ codes. Examples of such posting codes are Cash Expenditure, Cash, Collected Earned & Unearned Revenues. Intra governmental journal 30-6 receives and stores posting codes with a flag set in the value in the ‘Internal Fund field’, regardless of the event type.

Journal posting engine 25, after having successfully posted to all necessary journals, next changes flags in posting line catalog 20 from ‘Ready to Post’ to ‘Posted’ corresponding to the posting lines deposited into one or more of journals 30-1, 30-2, 30-3, 30-4, 30-5, 30-6, and 30-7. Journals 30-1, 30-2, 30-3, 30-4, 30-5, 30-6, and 30-7 are used for illustrative purposes; advantageously, the present invention may post to any type of journal not explicitly defined herein.

Ledger posting engine 35 receives records from one or more of journals 30-1, 30-2, 30-3, 30-4, 30-5, 30-6, and 30-7, and writes the received records to one or more ledgers 40. It is to be understood that ledgers 40 comprises one or more ledgers, including but not limited to accounting period ledgers, BFY ledgers, FY ledgers, and ITD ledgers, for example. Further, the method for determining which of ledgers 40 needs updating, and how the updating occurs, is user-configurable.

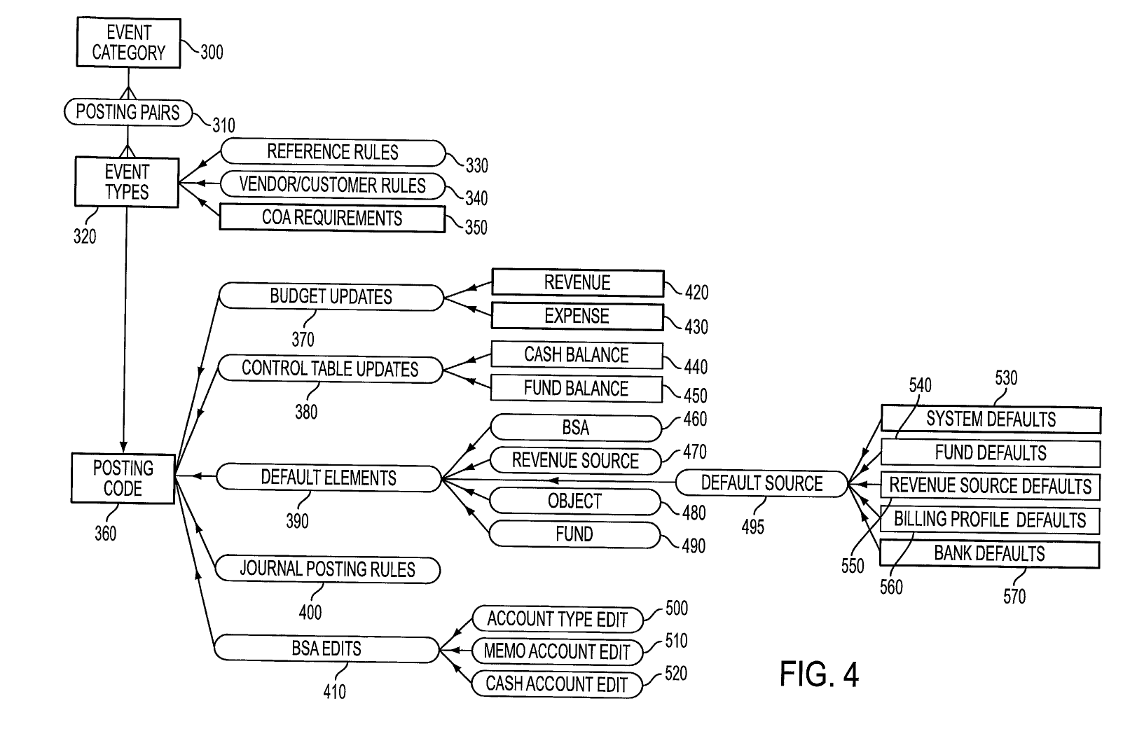

FIG. 4 is a data relationship diagram depicting the data relationships between an event category, event types, and posting codes. Event type category 300 is associated with posting pairs 310 created for each of the plurality of event types 320 belonging to a particular event category 300. Posting pairs 320 may be generically lettered by event category and logically named to a user of the system, so that connections between a pair of posting codes may be consistently made on the event type table. Moreover, when referencing prior documents, the present invention automatically determines the set of posting codes for the new event to apply to a referenced accounting line. For example, any posting line created for a particular posting pair on a payment request document retrieves two posting codes defined for that particular posting pair when posting. Next, when the payment request document is referenced by disbursement document, such as an automatic check document, the accounting system of the present invention determines that the check document needs a penalty line because payment made was overdue.

According to an aspect of the present invention, event types are created based on different possible types of accounting activities performed by documents 10. Event types 320 are controlled by user-definable reference rules 330, user-definable vendor/customer rules 340, and COA requirements 350. Advantageously, the rules 330 and 340 and requirements 350 are stored in user-definable databases, as state governments, local governments, and educational institutions may all have unique laws and policies that govern how accounting is to be recorded within the guidelines of the Governmental Accounting Standards Board.

Posting code 360 compartmentalizes event types 320 into individual accounting elements. There are typically at least two elements to an accounting event—a debit and a credit. These smaller components are referred to in the accounting field as either accounts, account types, or types of accounts. The present invention coins the term posting code to refer to the elements of an accounting event, since posting codes represent the debit and credit postings performed as a result of an accounting event.

As with event types 210, posting code 360 is controlled by table driven business rules which control many of the application updates made when a particular posting code is utilized. Such updates include budget updates 370 and control table updates 390. In turn, budget updates 370 are associated with revenue database 420 and expense database 430, and control table updates 380 is associated with cash balance database 440 and fund balance database 450.

Posting code 360 is also controlled by default elements 390, journal posting rules 400, and BSA edits 410. BSA edits 410, in turn, is associated with account type edit database 500, memo account edit database 510, and cash account edit database 520. Default elements 390, in turn, is associated with BSA 460, revenue source 470, default sources 495, object 480, and fund 490. Default sources 495 is associated with system defaults 530, find defaults 540, revenue source defaults 550, billing profile defaults 560, and bank defaults 570.

Posting code 360 contains instructions such as updating budget tables, updating accounting control tables, which journals to post to, default elements and the sequence for finding default elements, and defaulted or entered balance sheet codes.

The table driven accounting system of the present invention can have changes and/or additions made to the above-mentioned reference rules 330, vendor/customer rules 340, COA requirements 350, budget updates 370, control table updates 380, default elements 390, journal posting rules 400, and BSA edits 410. All of these maybe modified in real-time without the need for recompilation of source code controlling the accounting system. Thus, these table-based rules and updates may be changed with minimal effort as governmental and accounting rules change. Further, business rules may be added, changed, or modified quickly and easily. As a result, significant control is placed online where changes to the rules may be made and tested quickly by non-technical personnel; additional accounting events and posting codes may be added in real-time to perform needed functions without the need to recompile source code; and, the result of choosing a given set of rules may be quickly determined by viewing table settings.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for accounting, comprising:
executing accounting transactions; and
creating and storing posting lines based upon the accounting transactions.

2. The method for accounting according to claim 1, further comprising:
displaying the posting lines before the posting lines are posted.

3. The method for accounting according to claim 1, further comprising:
correcting the transactions before the posting lines are posted.

4. The method for accounting according to claim 1, further comprising:
correcting the posting lines before the posting lines are posted.

5. The method for accounting according to claim 1, further comprising:
consolidating a plurality of posting lines.

6. The method for accounting according to claim 1, further comprising:
modifying accounting transaction amounts without the need to refer back to previous accounting transaction amounts.

7. The method for accounting according to claim 1, further comprising:
posting the posting lines online or offline.

8. The method for accounting according to claim 1, further comprising:
determining whether to create posting lines based on the accounting transactions.

9. A method for accounting, comprising:
performing accounting transactions;
storing the outcome of processing the accounting transactions in a single catalog for accounting updates; and
verifying the outcome of processing the accounting transactions before the accounting transactions are posted to budget and/or accounting files.

10. The method for accounting according to claim 9, further comprising:
modifying the accounting transactions before the transactions are posted.

11. The method for accounting according to claim 9, further comprising:
modifying accounting transaction amounts without the need to refer back to previous accounting transaction amounts.

12. The method for accounting according to claim 9, further comprising:
updating the catalog online or offline.

13. The method for accounting according to claim 9, further comprising:
determining whether to store the outcome based on the accounting transactions.

14. A method for altering the behavior of an accounting system, comprising:
modifying table-based rules controlling posting lines in real-time without the need for recompilation of source code controlling the accounting system.

15. A computer implemented accounting system, comprising:
a rules processing unit for executing accounting transactions;
a posting line generation unit for creating posting lines based upon the transactions; and
a posting line catalog for storing the posting lines.

16. A computer implemented accounting system, comprising:
an engine for entering accounting transactions;
a posting line generation unit for creating posting lines based upon the transactions; and
a posting line archive unit for archiving the posting lines.

17. A computer implemented accounting system, comprising:
a plurality of database units storing user-modifiable rules for controlling posting line generation in real-time without the need for recompilation of source code controlling the accounting system.

18. A posting line data-structure, comprising:
a posting line identifier;
accounting line information;
referencing information;
offsetting information;
status flags;
chart of accounts;
amounts and dates; and
an internal identifier.

19. A method for accounting, comprising:
splitting a posting line having an amount into a plurality of separate posting lines each having separate amounts, wherein the sum of the separate amounts equals the amount of the posting line before splitting.

20. A method for accounting, comprising:
creating and storing posting lines based upon executed accounting transactions;
creating budget and/or accounting files based on the posting lines; and
recreating budget and/or accounting files based on the posting lines.

21. The method for accounting according to claim 20, wherein the accounting files are journal files.

22. The method for accounting according to claim 20, wherein the accounting files are application files.
